(19) United States
(12) Patent Application Publication
(10) Pub. No.: US 2026/0247244 A1
(43) Pub. Date: Aug. 20, 2026

(54) Link Assurance for Seamless Roaming

(71) Applicant: Apple Inc., Cupertino, CA (US)

(72) Inventors: Chittabrata Ghosh, San Jose, CA (US); Pooya Monajemi, Sunnyvale, CA (US); Jarkko L. Kneckt, Los Gatos, CA (US); Yong Liu, Campbell, CA (US); Anuj Batra, Redwood City, CA (US); Charles F. Dominguez, San Carlos, CA (US)

(21) Appl. No.: 19/533,616

(22) Filed: Feb. 9, 2026

Related U.S. Application Data
(60) Provisional application No. 63/758,621, filed on Feb. 14, 2025.

(51) Int. Cl. H04W 36/18; H04L 1/00; H04W 36/08

(52) U.S. Cl. CPC H04W 36/18; H04L 1/0003; H04W 36/08

(57) ABSTRACT

This disclosure relates to methods for link assurance for seamless roaming operation in a wireless local area network. A non-access point wireless device can generate and provide, to a serving access point, a request for link assurance from a candidate access point. The serving access point can provide resource context information for the non-access point wireless device to the candidate access point, and can receive link assurance request decision information from the candidate access point. The serving access point can provide, to the non-access point wireless device, a response to the request for link assurance that indicates the link assurance request decision of the candidate access point.

### PRIORITY INFORMATION

This application claims priority to U.S. provisional patent application Ser. No. 63/758,621, entitled “Link Assurance for Seamless Roaming,” filed Feb. 14, 2025, which is hereby incorporated by reference in its entirety as though fully and completely set forth herein.

### TECHNICAL FIELD

The present application relates to wireless communication, including techniques and devices for performing link assurance for seamless roaming in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Providing strong support for mobility, potentially including for roaming between access points in a WLAN setting, can provide significant benefits for mobile devices, but can also come with additional design challenges. Accordingly, improvements in the field are desired.

### SUMMARY

Embodiments are presented herein of, inter alia, systems, apparatuses, and methods for devices to perform link assurance for seamless roaming operation in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a wireless device can request link assurance for one or more candidate access points for possible roaming operation. The link assurance can be requested by way of the current serving access point for the wireless device, which in turn can provide resource context information to and obtain link assurance decision information from the candidate access point(s) from which link assurance is requested. The serving access point can the provide a link assurance response to the wireless device to indicate the link assurance decision(s).

The link assurance request(s) can be used to check whether certain links and/or link operating parameters would be available to the wireless device if the wireless device were to perform roaming to the candidate access point(s), e.g., to help better inform the wireless device's roaming decisions in view of its current application needs. It can be the case that when link assurance is provided by a candidate access point, the link assurance is provided for a limited time period, which can be indicated in the link assurance decision information and the link assurance response. In this case, any resources committed in the link assurance decision can be considered available to the wireless device in case of roaming until expiration of that time period. It can also potentially be possible to request renewal of such a link assurance decision, e.g., to extend the time period for which any resources committed in the link assurance decision can be considered available to the wireless device in case of roaming.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for implementing link assurance for seamless roaming operation in a wireless local area network, according to some embodiments;

FIG. 6 illustrates example aspects of a possible scenario in which a link assurance mechanism could be used, according to some embodiments;

FIG. 7 illustrates an example of a possible roaming preparation flow that includes use of a link assurance mechanism, according to some embodiments;

FIG. 8 illustrates an example link assurance communication flow in which link assurance is initiated with 3 candidate access points, according to some embodiments;

FIG. 9 illustrates an example of a link assurance request/response exchange including possible details of resource context information that could be provided, according to some embodiments;

FIG. 10 is a table illustrating possible allowed link uses for different link setup states and for access point signaled link assurance states, according to some embodiments;

FIG. 11 illustrates example aspects of a link assurance signaling flow in which a link assurance timeout interval is implemented, according to some embodiments;

FIG. 12 illustrates example aspects of a possible timeout interval element (TIE) that can be used to signal a link assurance timeout interval, a link setup timeout interval, and/or other types of timeout intervals, according to some embodiments; and

FIG. 13 illustrates example aspects of a possible signal flow for performing link assurance after roaming, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:
Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.
Carrier Medium—a memory medium as described above, as well as a physical transmission medium, such as a bus, network, and/or other physical transmission medium that conveys signals such as electrical, electromagnetic, or digital signals.
Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.
Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.
Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.
Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.
Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.
IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.
Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

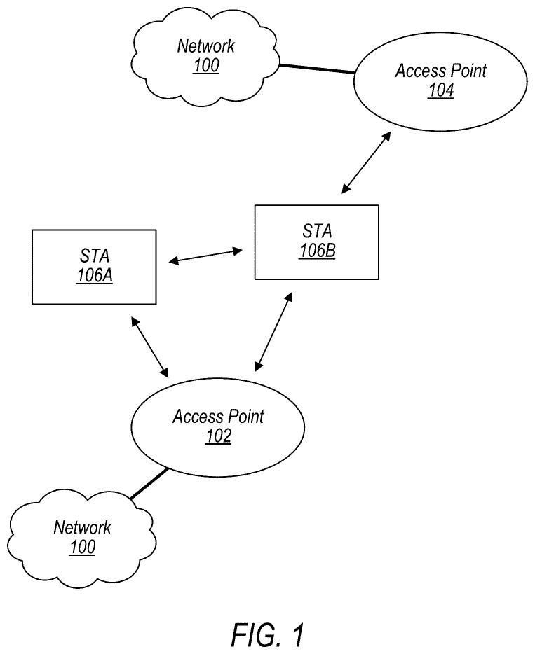

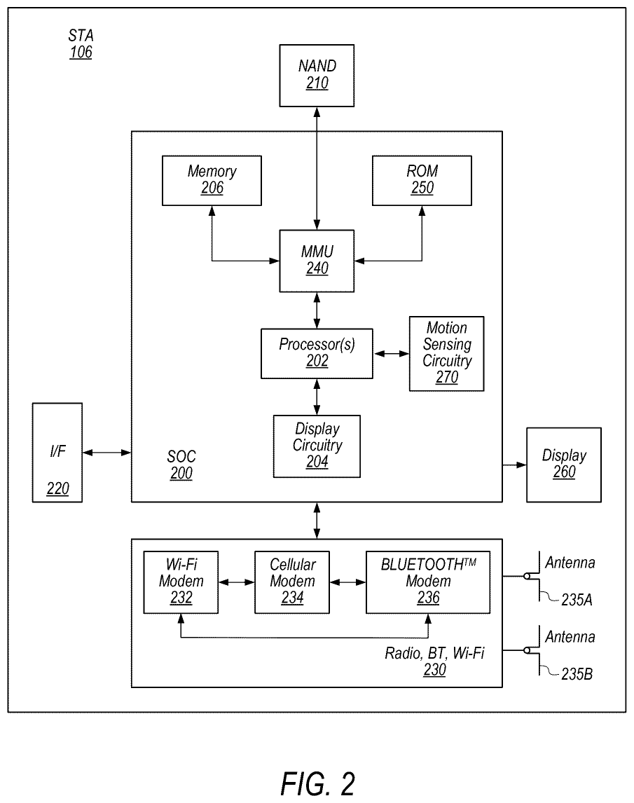

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for implementing link assurance for seamless roaming operation in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for achieving link assurance for seamless roaming operation described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

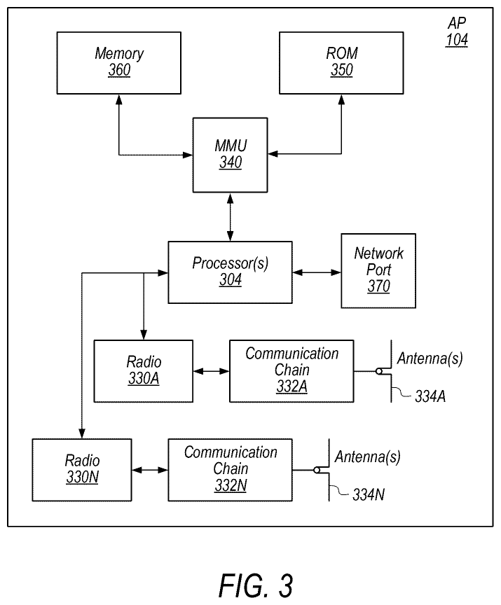

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as performing link assurance for seamless roaming operation, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

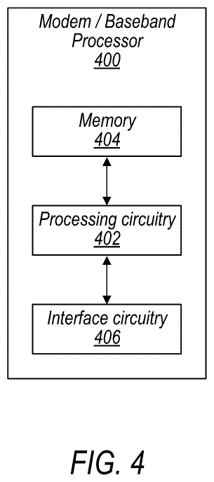

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 can implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as performing link assurance for seamless roaming operation, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

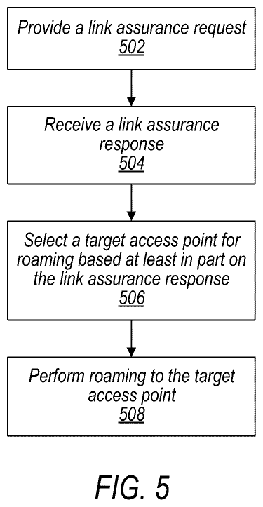

### FIG. 5—Link Assurance Flowchart

FIG. 5 is a flowchart diagram illustrating a method for supporting link assurance for seamless roaming in a WLAN, according to some embodiments. In various embodiments, one or more of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

An access point (AP) wireless device may provide one or more basic service sets (BSSs). In some embodiments, the AP wireless device may be an AP multi-link device (MLD), which may be capable of providing a BSS on each of multiple links, such as on a 2.4 GHz link, a 5 GHz link, and/or a 6 GHz link. The AP wireless device may operate in a standalone manner or may be affiliated with one or more other devices, e.g., as part of a larger network. For example, the AP wireless device can be a member of a multi-link multi-device (MLMD) or seamless mobility domain (SMD) logical entity, which could include multiple AP wireless devices, in some embodiments.

The AP wireless device may establish a wireless association with one or more non-AP station (or “STA”) wireless devices. Such wireless associations may be established using Wi-Fi, wireless communication techniques that are based at least in part on Wi-Fi, and/or any of various other wireless communication technologies, according to various embodiments. For example, an AP wireless device may provide (e.g., broadcast) beacon transmissions, including information for associating with the AP wireless device, and one or more other wireless devices (e.g., non-AP wireless devices) may request to associate with the AP wireless device using the information provided in one or more of the beacon transmissions, as one possibility. Probe requests and probe responses (e.g., unicast) may also be used, in some instances, for a non-AP wireless device to obtain AP parameters and/or other system information associated with the AP wireless device. Variations and/or other techniques for establishing an association are also possible.

The AP wireless device may provide wireless local area network (WLAN) functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

For example, at least according to some embodiments, performing a downlink data transmission from the AP wireless device to a non-AP wireless device in such a wireless local area network may include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs). Note that other types of transmissions (e.g., including triggered uplink frames, enhanced distributed channel access (EDCA) uplink frames, transmission opportunity (TXOP) sharing for peer-to-peer (P2P) communications, etc.) may also be possible in such a wireless local area network.

A non-AP wireless device associated with an AP wireless device can perform neighbor AP discovery. This can include performing scanning operations, receiving neighbor AP information from a serving AP wireless device, sending probe requests to neighbor AP wireless device, and/or any of various other operations, to obtain information regarding neighbor AP wireless devices that could potentially be available for roaming.

The non-AP wireless device can potentially select one or more of the discovered neighbor AP wireless devices as candidate APs for access point assisted (or “seamless”) roaming, for example based on signal strength, loading, operating characteristics (e.g., number of links, link bandwidth, etc.), and/or any of various other types of information, if available to the non-AP wireless device.

For one or more of the selected candidate APs, the non-AP wireless device can generate a link assurance request (502). The link assurance request(s) can be provided to the serving AP wireless device, for example using over-the-air (OTA) signaling via an existing link with the serving AP wireless device. Such a link assurance request can request that link assurance be provided by a candidate AP, e.g., to ensure that one or more requested links (possibly with one or more requested characteristics) would be available to the non-AP wireless device for performing roaming to the candidate AP. Note that at least in some embodiments, it can be the case that a link assurance request can request link assurance from multiple candidate APs. Alternatively, it can be the case that a separate link assurance request is provided for each candidate AP from which link assurance is requested.

A link assurance request can indicate that assurance for one or more specific links (e.g., a 2.4 GHz link, a 5 GHz link, and/or a 6 GHz link) is requested, and/or that assurance for a certain number of links is requested. In some embodiments, such an indication can be explicit, while in other embodiments, such an indication can be implicit; for example, it can be the case that if no explicit/specific set of links is requested, a default assumption can be defined that the link assurance request is for all links operated by the candidate AP.

The link assurance request can additionally or alternatively indicate one or more requested resources and/or operating parameters for the link(s) for which link assurance is requested, in some embodiments. For example, a specific traffic identifier to link mapping (TTLM) could be requested for a link, or for multiple links, for which link assurance is requested. As further examples, for any or all requested links, a minimum and/or maximum stream classification service (SCS) service interval (SI) can be requested. Additionally or alternatively, any or all of a link bandwidth, a minimum data rate, a delay bound, a maximum MAC service data unit (MSDU) size, a service start time, a mean data rate, a MSDU lifetime, a number of spatial streams, and/or a modulation and coding scheme (MCS) can be requested. It can also be possible that default assumptions can be defined for any or all such operating parameters, e.g., such that if no explicit/specific values are indicated in the link assurance request for any or all such operating parameters, a predefined default requested value for one or more of those operating parameters is implicitly requested by the link assurance request.

The serving AP can check for the link assurance decision(s) from the candidate AP(s) from which link assurance is requested. This can include the serving AP providing resource context information (e.g., indicating wireless device identification information, such as MLD/MAC address, as well as the requested resources and/or operating parameters) for the link assurance request(s) to the corresponding candidate AP(s). In turn, the candidate AP(s) from which link assurance is requested can provide the link assurance decision indication(s) to the serving AP. Such an exchange can be performed via a distribution system (DS), via a backhaul link, and/or using OTA signaling, among various possibilities.

The link assurance decision from a candidate AP corresponding to a link assurance request can indicate an acceptance of the link assurance request, e.g., in which the candidate AP provides assurance that the requested link(s) (and possibly all of the requested link parameters) would be available to the non-AP wireless device when roaming to the candidate AP, as one possibility. In some embodiments, a partial or modified acceptance of the link assurance request can be provided, e.g., in which the candidate AP provides assurance that at least one of the requested links (possibly with one or more modifications to one or more of the requested link parameters) would be available to the non-AP wireless device when roaming to the candidate AP. As still another possibility, the link assurance decision can indicate a rejection of the link assurance request, e.g., in which the candidate AP indicates that it does not provide assurance of the requested link(s). Note that it can be the case that a rejection of a link assurance request need not necessarily mean that a candidate AP would reject a roaming request from the non-AP wireless device.

In some embodiments, the candidate AP(s) can provide an indication of a link assurance timeout interval corresponding to the link assurance decision. For example, such an indication could be provided in a timeout interval element (TIE), as one possibility. At least as one possibility, countdown of the link assurance timeout interval can begin from a timestamp of the link assurance request. In other embodiments, a different starting point (e.g., the time of the link assurance response or a different indicated time) can be used or an expiry time can be indicated. This interval can be used to identify a time window during which the link assurance decision is valid; for example, until expiration of the link assurance timeout interval for a candidate AP, that AP can be expected to provide the assured resources to the non-AP wireless device if the non-AP wireless device performs link addition with that AP, while after expiration of the link assurance timeout interval for a candidate AP, that AP is no longer committed to provide the assured resources to the non-AP wireless device if the non-AP wireless device performs link addition with that AP, at least according to some embodiments.

The serving AP can provide a link assurance response to the non-AP wireless device (504), e.g., based at least in part on the link assurance decision information received from the candidate AP(s). The link assurance response can indicate whether the candidate AP(s) provided acceptance, or partial acceptance, or rejection of the link assurance request(s). In some embodiments, for a partial acceptance, the link assurance response can indicate suggested alternate values for one or more requested parameters (e.g., number of links and/or different specific links, SCS parameters, TTLM) for which the corresponding candidate AP agrees to provide link assurance. In some embodiments, the link assurance response can also provide an indication of a link assurance timeout interval corresponding to the link assurance decision (e.g., if provided), for example in a TIE, as one possibility. In some other embodiments, the link assurance response can indicate the expiry of the link assurance in a different form, e.g., an expiration time.

The non-AP wireless device can select a target AP for roaming based at least in part on the link assurance response (506). This can include selecting a candidate AP that provides the requested link assurance, or that provides a closest partial acceptance link assurance decision to the requested link assurance, in some embodiments. It can also be possible that the selection of the target AP does not correspond directly to the closest link assurance decision to the requested link assurance, e.g., as other factors can also be included in the target AP selection processor, at least in some embodiments.

The non-AP wireless device can perform roaming to the target AP (508). This can include performing link addition (e.g., including exchanging link addition request/response signaling with the serving AP), as well as DS mapping switching and roaming completion (e.g., including exchanging roaming initiation/complete signaling with the target AP), at least according to some embodiments. Note that in some embodiments, a link setup timeout interval, e.g., which can also potentially be signaled using a TIE, can be used as part of the roaming process. For example, a link setup timeout interval value could be indicated in a link addition response, and could be configured to indicate a length of time within which to perform roaming initiation; for example, until expiration of the link addition timeout interval for a target AP, that AP can be expected to accept a roaming initiation request, while after expiration of the link addition timeout interval for a target AP, that AP may delete the added link and context for the non-AP wireless device, and the non-AP wireless device may be expected to abandon that roaming attempt, at least according to some embodiments.

In some embodiments, link assurance renewal can be supported. Such link assurance renewal can, for example, be performed by a non-AP wireless device prior to expiration of a link assurance timeout interval, e.g., to extend the period of time for which a candidate AP provides link assurance to the non-AP wireless device. Note that this link assurance renewal can be performed with the serving AP of the non-AP wireless device, which could be the same AP with which link assurance for the candidate AP was initially performed, or could potentially be a different AP, e.g., if roaming to a target AP is completed after link assurance for the candidate AP was initially performed.

To perform such link assurance renewal, a non-AP wireless device can generate and provide (e.g., using OTA signaling via an established link with the serving AP) a link assurance renewal request to the serving AP. The serving AP can provide (e.g., via DS, backhaul link, OTA signaling, etc.) an indication of the request for link assurance renewal to the candidate AP. The candidate AP can determine a link assurance renewal decision for the link assurance renewal request, which could include an accept decision, a partial or modified accept decision or a reject decision. It can be the case that the candidate AP is under no obligation to renew a link assurance renewal request, e.g., even if it previously accepted an initial link assurance request and/or one or more previous link assurance renewal requests, at least according to some embodiments. The candidate AP can provide link assurance renewal decision information (e.g., to indicate its link assurance renewal decision) to the serving AP. The serving AP can then provide a link assurance renewal response to the non-AP wireless device to indicate the link assurance renewal decision for the candidate AP. Note that in some instances, it may be possible for a link assurance renewal request to be used to request multiple link assurance renewals (e.g., corresponding to different candidate APs), and/or for a link assurance renewal response to be used to respond to multiple link assurance renewal requests.

Thus, according to the method of FIG. 5, it can be possible to perform link assurance signaling, which can result in more effective and reliable roaming operation, at least according to some embodiments.

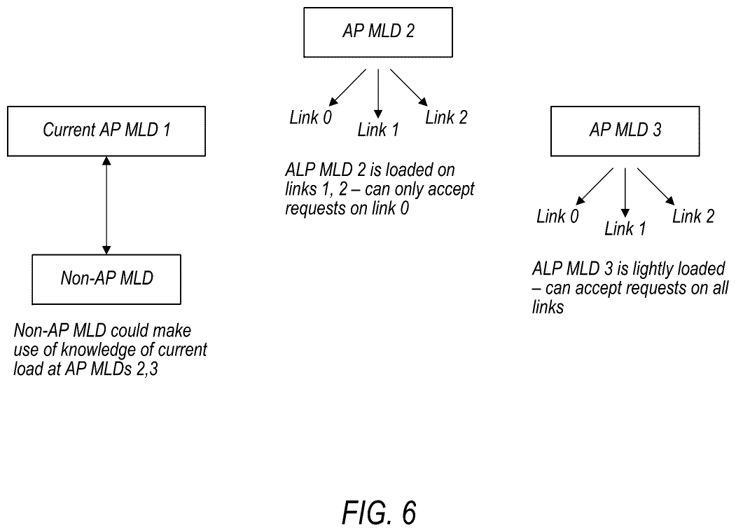

### FIGS. 6-13 and Additional Information

FIGS. 6-13 illustrate further aspects that might be used in conjunction with the method of FIG. 5. It should be noted, however, that the exemplary details illustrated in, and described with respect to, FIGS. 6-13 are not intended to be limiting to the disclosure as a whole: numerous variations and alternatives to the details provided herein below are possible and should be considered within the scope of the disclosure.

Access point facilitated roaming, which can also sometimes be referred to as seamless roaming, can allow a wireless device to quickly transition from active association with one AP device to another AP device. For seamless roaming, a set of AP multi-link devices (MLDs) can be grouped into a virtual entity, which can be referred to as a multi-link multi-device (MLMD), or as a seamless mobility domain (SMD), among various possibilities, e.g., to help coordinate certain management functions among the set of AP MLDs. Roaming between AP MLDs in a MLMD or SMD can potentially be faster and more efficient, with less interruption to the roaming STA MLD. Once a STA is associated with an AP MLD in such a system, the STA can potentially keep its authentication and association state in roaming to another AP MLD.

As part of a seamless roaming procedure, before the request/response exchange requesting the roaming transition from a current AP MLD to a target AP MLD, a roaming preparation procedure can be performed, which can include transfer or renegotiation of the context to a target AP MLD, and setting up the link(s) with a target AP MLD. As one possibility, a recommendation mechanism could be provided for the serving AP MLD, for example in which a list of potential candidate AP MLDs could be provided to a non-AP MLD, e.g., to potentially reduce a ping-pong effect impacting roaming and leading to data interruption. However, even with such a mechanism, it can be the case that while roaming, a non-AP MLD has no knowledge of whether the requested link(s) will be accepted by the target AP MLD. Rejection of a link setup request can result in roaming latency, as the non-AP MLD can need to re-initiate roaming setup. Even partial acceptance of a link setup request can potentially result in performance degradation after roaming.

A link assurance mechanism, such as described herein, can thus be used to improve seamless roaming performance, for example by enabling a non-AP MLD to obtain assurance, prior to roaming, that one or more AP MLDs have links and/or other resources available to sustain its performance, at least according to some embodiments.

FIG. 6 illustrates example aspects of a possible scenario in which such a link assurance mechanism could be used, according to some embodiments. As shown, in the illustrated scenario, a non-AP MLD is initially served by AP MLD 1. Neighboring AP MLD 2 has 3 links and is loaded on links 1 and 2 such that it can only accept requests on link 0, while neighboring AP MLD 3 is lightly loaded and can accept requests on all links. In this scenario, it can be useful for the non-AP MLD to have knowledge of the current load at AP MLDs 2 and 3 to support a better-informed roaming decision, which can potentially lead to better efficiency and/or performance at the non-AP MLD.

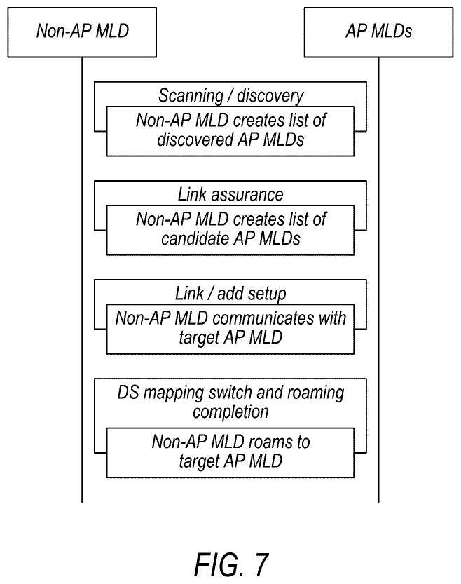

FIG. 7 illustrates an example of a possible roaming preparation flow that includes use of a link assurance mechanism, according to some embodiments. As shown, in a scanning/discovery phase, a non-AP MLD can create a list of discovered AP MLDs. For example, in residential and enterprise networks, each mobile device can typically discover at least a subset of AP MLDs in proximity to the mobile device; this subset of AP MLDs can be referred to as discovered AP MLDs herein. The non-AP MLD can create this list based on scanning operations, via communication with a serving AP MLD, and/or via any of various other possible mechanisms, according to various embodiments.

In a link assurance phase, a non-AP MLD can inquire about resources available for one or more candidate AP MLDs (which can be a further subset of AP MLDs selected from the discovered AP MLDs). In some embodiments, the non-AP MLD can specify the links it wants to operate, for example. This inquiry can be tunneled through the serving AP MLD. This link assurance step can be based on resource requirements for the non-AP MLD and can potentially reduce roaming request rejections and improve roaming reliability. A non-AP MLD can thus potentially receive a commitment of resources (e.g., overall QoS, stream classification service (SCS), available links, etc.) from candidate AP MLDs prior to roaming.

The non-AP MLD can select a target AP MLD for roaming based at least in part on the link assurance(s) received, and can set up one or more links with that target AP MLD in the link add/setup phase, as illustrated. The requested resources can be reserved for the non-AP MLD and association states can be maintained by both AP MLDs. Distribution system (DS) mapping switching and roaming completion can be performed to complete the roaming of the non-AP MLD to the target AP MLD.

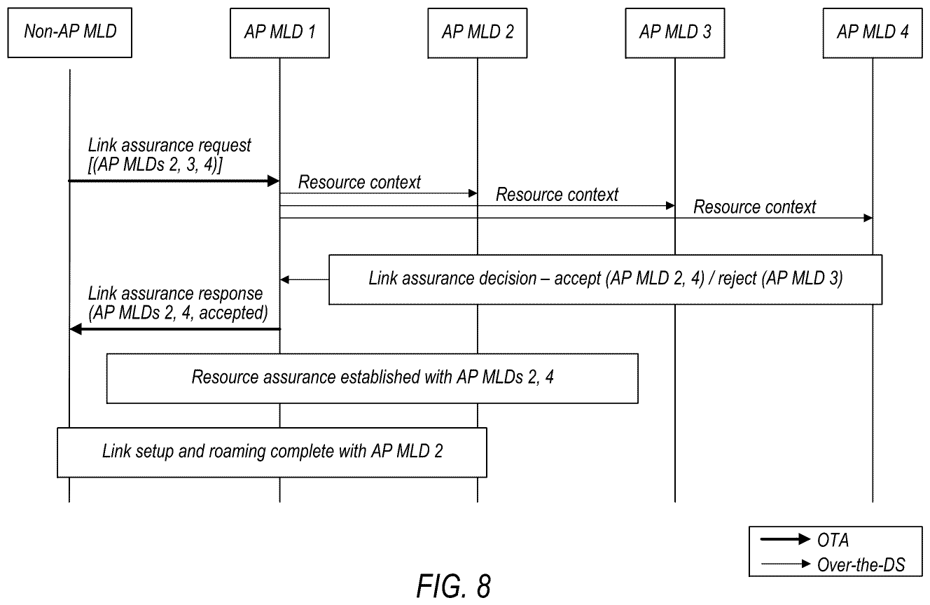

A non-AP MLD performing link assurance can initiate the link assurance with one or more candidate AP MLDs. FIG. 8 illustrates an example link assurance communication flow in which link assurance is initiated with 3 candidate AP MLDs, according to some embodiments. In the illustrated example, the non-AP MLD initiates the link assurance by transmitting (e.g., using over-the-air (OTA) signaling) a link assurance request to AP MLD 1, which can initially be a serving AP MLD for the non-AP MLD. The non-AP MLD can request link and QoS assurance over one or multiple links. The non-AP MLD can share resource context regarding how it expects to operate on the link(s). An AP MLD can reject all assurance on all links (failed assurance) or assure at least one link indicated by the STA with or without QoS assurance (partial or complete assurance). An AP MLD can specify the link(s) that are available for the non-AP MLD to operate. Thus, in the illustrated example, AP MLD 1 can provide resource context to AP MLD 2, AP MLD 3, and AP MLD 4, and receive link assurance decision responses indicating an accept decision from AP MLDs 2, 4, and a reject decision from AP MLD 3. Signaling between the AP MLDs can be over the DS (e.g., via backhaul and/or OTA links), among various possibilities. The AP MLD 1 can then provide a link assurance response to the non-AP MLD indicating that AP MLDs 2, 4 accepted. If a link assurance request is accepted by a candidate AP MLD, such as by AP MLDs 2, 4, in the illustrated scenario, it can be specified that resources shall be committed for the requesting non-AP MLD if it intends to roam to this AP MLD, e.g., at least for a certain time window.

In some instances, the requesting STA can provide any or all of the following resource context in the link assurance request: the MLD address of the non-AP MLD (e.g., a MAC address, to signal the MLD that has reserved the resources), the link(s) in which the non-AP MLD expects to operate, the supported bandwidth (BW), modulation and coding scheme (MCS), and number of spatial streams (Nss) of non-AP STAs on the requested links, and/or the SCS requirements (e.g., the QoS characteristics, such as minimum and maximum service interval (SI) of the SCS stream). Note that at least according to some embodiments, default requests can be defined for scenarios in which no explicit indication is provided for a certain type of resource context in the link assurance request. For example, in the absence of explicit link request information, all links of an AP MLD can be requested for link assurance. In the absence of traffic identifier to link mapping (TTLM) information, default TTLM can be requested for link assurance. In the absence of information on BW, Nss, and MCS in resource context, a default BW and Nss (e.g., BW=80 MHz, Nss=2, as one possibility; other values are also possible) can be assumed for the non-AP MLD.

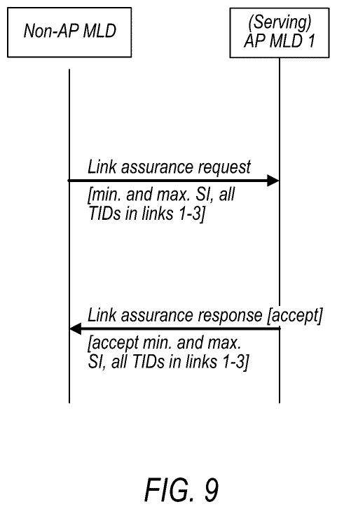

FIG. 9 illustrates an example of a link assurance request/response exchange including further possible details of the resource context information that could be provided, according to some embodiments. In the illustrated example, the link assurance request indicates requested minimum and maximum service interval values, and that all TIDs are requested to be mapped to links 1-3. In this case, the AP MLD 1 provides a link assurance response accepting the link assurance request, and thus assuring the requested minimum and maximum service interval values and that all TIDs can be mapped to links 1-3 for the requested candidate AP MLD(s).

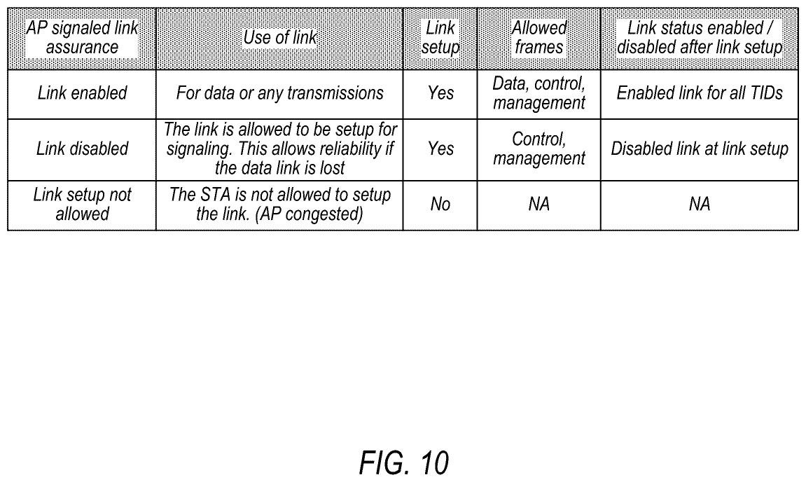

It can be the case that a candidate AP MLD's assurance guarantees just the agreed link(s) or both the agreed link(s) and QoS characteristics, according to various embodiments. In other words, as one possibility (e.g., as a default option) traffic QoS can be expected to be met on the assured link(s), while as another possibility, recommended links can be used for data transmission, but QoS, delay, and frame loss are not guaranteed for the assured link(s). When a candidate AP MLD assures one or more links, it can be the case that a non-AP MLD is allowed to use the link(s) as explicitly signaled by the candidate AP MLD. The link setup can be considered successful if the assured links, or at least a subset of the assured links, are setup, at least according to some embodiments. FIG. 10 is a table illustrating possible allowed link uses for different link setup states and for AP signaled link assurance states, according to some embodiments.

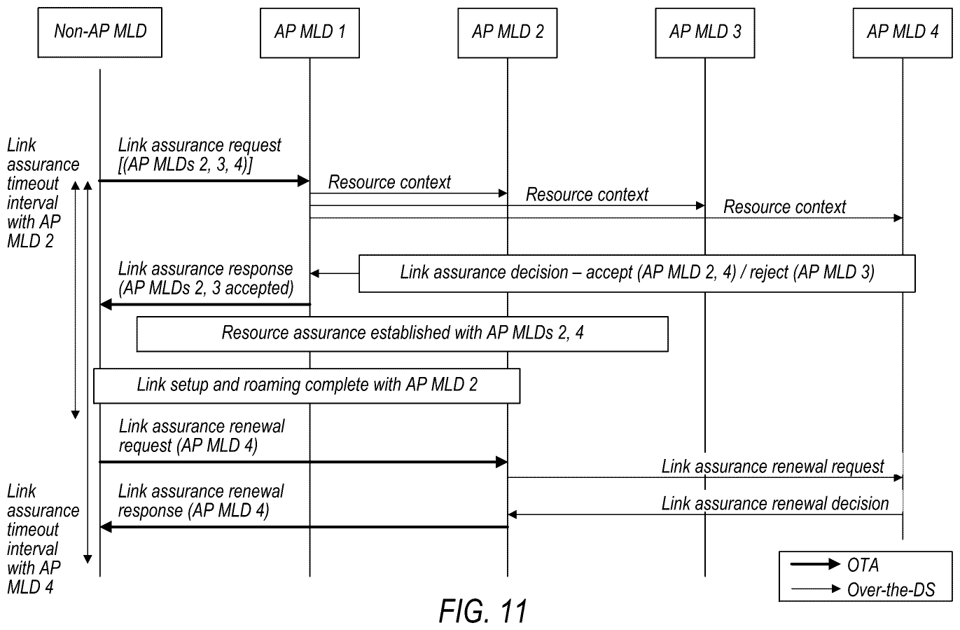

As previously noted herein, it can be the case that a candidate AP MLD that accepts a link assurance request assures certain resources for the requesting non-AP MLD, at least for a certain time window. FIG. 11 illustrates example aspects of a link assurance signaling flow in which a link assurance timeout interval is implemented, e.g., to limit the time period for which a candidate AP MLD is expected to assure resources for a non-AP MLD after accepting a link assurance request, at least according to some embodiments.

In the illustrated example scenario, link assurance is available for a link assurance timeout interval, which can be indicated by each candidate AP MLD. The link assurance response can indicate the timeout interval information, at least in some instances. As illustrated, while the timeout interval value can be indicated in the link assurance response, the timeout interval can begin from the link assurance request transmission timestamp, e.g., to support timing synchronization between the non-AP MLD and the AP MLDs. Within a link assurance timeout interval, a non-AP MLD can potentially initiate roaming with a target AP MLD that has provided an accept response to a link assurance request with corresponding resource assurance. For example, in the illustrated scenario, the non-AP MLD performs link setup and completes roaming with AP MLD 2 prior to the link assurance timeout interval expiry with AP MLD 2. Additionally, or alternatively, within a link assurance timeout interval, a non-AP MLD can potentially renew the link assurance with a candidate AP MLD. For example, in the illustrated scenario, the non-AP MLD provides a link assurance renewal request for AP MLD 4 (e.g., to AP MLD 2, which is the serving AP MLD for the non-AP MLD as roaming to AP MLD 2 has been completed) prior to the link assurance timeout interval expiry with AP MLD 4. Similar to the link assurance request/response flow, this can also trigger an over-the-DS exchange between the serving AP MLD and the candidate AP MLD(s) to determine the link assurance renewal decision for the candidate AP MLD(s), and the serving AP MLD can provide a link assurance renewal response to the non-AP MLD to indicate whether the link assurance renewal request is (e.g., partially or completely) accepted or rejected.

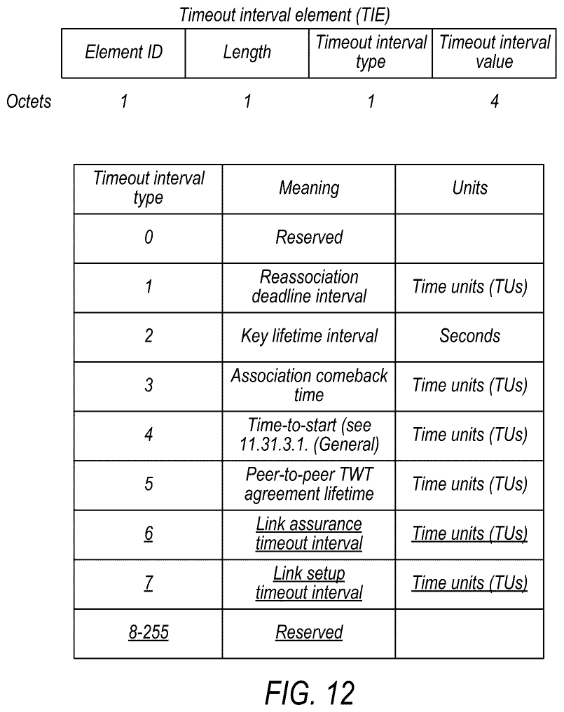

FIG. 12 illustrates example aspects of a possible timeout interval element (TIE) that can be used to signal a link assurance timeout interval, among various other possible types of timeout intervals. As described herein, the link assurance timeout interval can indicate a duration for which an AP MLD commits resources to a non-AP MLD when the AP MLD accepts the link assurance request from the non-AP MLD. After expiration of this interval, it can be the case that an AP MLD may flush that resource commitment, at least according to some embodiments. After the expiration of the timeout interval, it can be specified that the non-AP MLD must re-initiate the link assurance mechanism. In the illustrated example, each candidate AP MLD can indicate its link assurance timeout interval in a TIE. Each interval can be defined such that resolution of this interval is in time units (TUs), with a specified default and maximum value, in some instances. Other definitions are also possible. In some embodiments, setting this value to 0 can indicate that no deadline or expiration for the link assurance is set.

In some embodiments, the TIE format illustrated in FIG. 12 can also potentially be used to indicate a link setup timeout interval. For example, for the link add and/or DS mapping switch and roaming completion phases of seamless roaming illustrated in FIG. 7, it can be the case that a target AP MLD can set a timeout interval (e.g., from when link addition is performed) by which a non-AP MLD is expected to initiate or possibly complete) roaming. If such a timeout interval expires without initiating roaming (or possibly without completing DS mapping switching), it can potentially be the case that the target AP MLD deletes/releases the link with the non-AP MLD, flushes context information for the non-AP MLD, and/or performs other operations terminating that roaming activity with the non-AP MLD, according to various embodiments. In such a scenario, it can be specified that the link addition mechanism must be reinitiated with the AP MLD. Similarly, it can be the case that the non-AP MLD abandons that roaming attempt upon expiration of such a timeout interval without initiating (or possibly completing) roaming. Similar to a link assurance timeout interval, it can be the case that this interval can be defined such that resolution of this interval is in time units (TUs), with a specified default and maximum value, in some instances. Other definitions are also possible. In some embodiments, setting this value to 0 can indicate that no deadline or expiration for the link setup is set.

It should be noted that other mechanisms for determining a link assurance timeout interval and/or a link setup timeout interval are also possible, potentially including techniques for implicitly determining one or more such intervals. For example, wireless communication technology technical specifications could define one or more fixed/default values, and/or SMD-wide system parameters could configure one or more values, for one or more of a link assurance timeout interval and/or a link setup timeout interval. In this case, in the absence of explicit indication of a link assurance timeout interval in a link assurance response, a default value for such parameters can be implicitly determined by a non-AP MLD and a candidate AP MLD, at least according to some embodiments.

Note that link assurance can be performed again and/or renewed even after roaming is completed, in some embodiments. For example, after a non-AP MLD has roamed to the target AP MLD, link assurance with each candidate AP MLD can be maintained until the link assurance timeout interval expires. The non-AP MLD can also potentially perform link assurance with the previous serving AP MLD. As another possibility, the non-AP MLD can also potentially send new link assurance request frames to candidate AP MLDs that have rejected previous link assurance requests. These AP MLDs can accept or reject such requests.

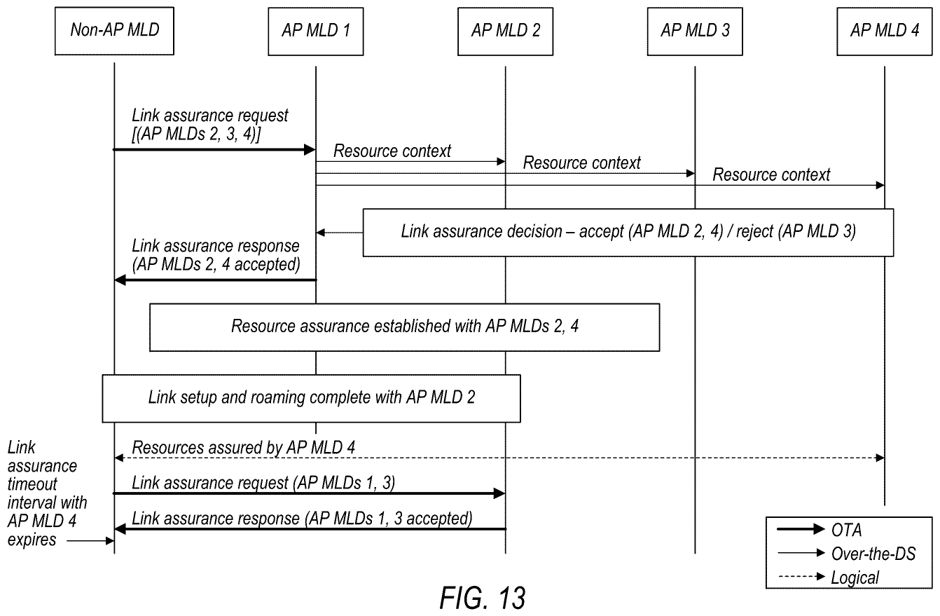

FIG. 13 illustrates example aspects of a possible signal flow for performing link assurance after roaming, according to some embodiments. As shown, link assurance and roaming from AP MLD 1 to AP MLD 2 can be completed by a non-AP MLD in a similar manner as in the example scenario of FIG. 11. Even after roaming is completed, the resources assured by AP MLD 4 can continue to be available, e.g., until the link assurance timeout interval with AP MLD 4 expires. Additionally, in the illustrated example scenario, the non-AP MLD can provide a new link assurance request for the former serving AP MLD 1 and the AP MLD 3 that previously rejected a link assurance request, and can receive a corresponding link assurance response, in this case indicating that AP MLDs 1, 3 accepted. Though not shown, AP MLD 2 can provide resource context to and obtain link assurance decisions from AP MLDs 1, 3 to be able to provide the link assurance response.

Thus, to facilitate effective seamless roaming, the techniques described herein can be used to perform a link assurance procedure with one or more candidate AP MLDs after initial association with a serving AP MLD. As described herein, the link assurance operations supported can include a non-AP MLD requesting to assure selected AP MLD link availability for roaming, as well as each AP MLD accepting, rejecting, or negotiating (e.g., providing partial acceptance for) the request for assurance. In various instances, an AP MLD may assure application QoS on one or multiple requested links, and/or may assure a set of links on which the requesting non-AP MLD may operate. Resource context can be shared with a candidate AP MLD to inform the link assurance decision, and a link assurance timeout interval can be defined with respect to initiation of a link assurance request.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
providing, to a serving access point (AP), a request for link assurance corresponding to one or more candidate APs, wherein the request for link assurance indicates at least one requested traffic identifier to link mapping (TTLM); and
receiving, from the serving AP, a response to the request for link assurance.

2. The method of claim 1,
wherein the request for link assurance indicates a multi-link device (MLD) address associated with the request for link assurance, and
wherein the request for link assurance indicates one or more links associated with each of the one or more candidate APs.

3. The method of claim 1,
wherein the request for link assurance indicates a Quality of Service (QoS) satisfying at least one of a minimum stream classification service (SCS) service interval (SI), a maximum SCS SI, a bandwidth, a minimum data rate, a delay bound, a maximum media access control service data unit (MSDU) size, a service start time, a mean data rate, a MSDU lifetime, a number of transmit spatial streams, a number of receive spatial streams, or a modulation and coding scheme (MCS).

4. The method of claim 1,
wherein the response to the request for link assurance indicates whether the request for link assurance is accepted.

5. The method of claim 1,
wherein the response to the request for link assurance indicates a partial acceptance of the request for link assurance, the partial acceptance comprising acceptance of at least one requested resource and rejection of at least one requested resource.

6. The method of claim 1, wherein the response to the request for link assurance indicates a link assurance timeout interval configured to indicate a length of time for which a link assurance configuration indicated in the response to the request for link assurance is valid.

7. The method of claim 6, wherein the link assurance timeout interval is indicated in a timeout interval element in the response to the request for link assurance.

8. The method of claim 6, wherein the method further comprises:
providing, to the serving AP, prior to expiration of the link assurance timeout interval, a link assurance renewal request; and
receiving, from the serving AP, a link assurance renewal response.

9. The method of claim 1, wherein the method further comprises:
selecting a target AP among the one or more candidate APs for roaming based at least in part on the link assurance response;
providing, to the serving AP, a link addition request for the target AP; and
receiving, from the serving AP, a link addition response indicating a link setup timeout interval configured to indicate a time by which to initiate roaming execution.

10. A processor comprising memory configured to cause the processor to perform operations comprising:
generating a link assurance request that requests assurance that one or more links associated with a candidate access point (AP) wireless device will be available when performing roaming to the candidate AP wireless device, wherein the link assurance request is configured for wireless transmission to a serving AP wireless device; and
receiving a link assurance response that indicates whether assurance is provided that the one or more links associated with the candidate AP wireless device will be available when performing roaming to the candidate AP wireless device.

11. The processor of claim 10, wherein the request for link assurance indicates at least one of:
a number of links;
a minimum stream classification service (SCS) service interval (SI);
a maximum SCS SI;
a traffic indicator to link mapping (TTLM);
a bandwidth;
a minimum data rate;
a delay bound;
a maximum media access control service data unit (MSDU) size;
a service start time;
a mean data rate;
a MSDU lifetime;
a number of spatial streams; or
a modulation and coding scheme (MCS).

12. The processor of claim 10, wherein the response to the request for link assurance includes at least one of:
an indication that the request for link assurance is accepted;
an indication that the request for link assurance is rejected; or
an indication of a modified acceptance of the request for link assurance.

13. The processor of claim 10,
wherein the response to the request for link assurance indicates an accepted link assurance configuration and a link assurance timeout interval value configured to indicate a length of time for which the accepted link assurance configuration is valid.

14. A first access point (AP) wireless device, comprising:
one or more antennas;
one or more radios operably coupled to the one or more antennas; and
a processor operably coupled to the one or more radios;
wherein the first AP wireless device is configured to:
receive, from a non-AP wireless device, a request for link assurance from at least a second AP wireless device;
provide, to at least the second AP wireless device, resource context information associated with the request for link assurance;
receive, from at least the second AP wireless device, link assurance request decision information; and
provide, to the non-AP wireless device, a response to the request for link assurance.

15. The first AP wireless device of claim 14,
wherein the request for link assurance includes wireless device identifier information for the non-AP wireless device, and
wherein the request for link assurance indicates one or more links associated with the second AP wireless device.

16. The first AP wireless device of claim 14,
wherein the request for link assurance indicates a Quality of Service (QoS) satisfying at least one of a minimum stream classification service (SCS) service interval (SI), a maximum SCS SI, a bandwidth, a number of transmit spatial streams, a number of receive spatial streams, or a modulation and coding scheme (MCS).

17. The first AP wireless device of claim 14,
wherein the request for link assurance indicates at least one requested traffic indicator to link mapping (TTLM).

18. The first AP wireless device of claim 14, wherein the response to the request for link assurance includes at least one of:
an indication that the request for link assurance from the second AP wireless device is accepted;
an indication that the request for link assurance from the second AP wireless device is rejected; or
an indication of a modified acceptance of the request for link assurance from the second AP wireless device.

19. The first AP wireless device of claim 14, wherein the response to the request for link assurance indicates an accepted link assurance configuration from the second AP wireless device and a link assurance timeout interval value configured to indicate a length of time for which the accepted link assurance configuration from the second AP wireless device is valid.

20. The first AP wireless device of claim 19, wherein the first AP wireless device is further configured to:
receive, from the non-AP wireless device, prior to expiration of the link assurance timeout interval, a request for renewal of the accepted link assurance configuration from the second AP wireless device;
provide, to the second AP wireless device, an indication of the request for renewal of the accepted link assurance configuration from the second AP wireless device;
receive, from the second AP wireless device, link assurance renewal decision information; and
provide, to the non-AP wireless device, a link assurance renewal response.
